(19) United States
(12) Patent Application Publication
(10) Pub. No.: US 2026/0178510 A1
(43) Pub. Date: Jun. 25, 2026

(54) CACHE RESIDENCY CONTROL

(71) Applicant: Advanced Micro Devices, Inc., Santa Clara, CA (US)

(72) Inventors: Trinayan Baruah, San Diego, CA (US); Joseph L. Greathouse, Austin, TX (US); Subramaniam Maiyuran, Folsom, CA (US); Mark Zheng, Orlando, FL (US)

(73) Assignee: Advanced Micro Devices, Inc., Santa Clara, CA (US)

(21) Appl. No.: 18/999,956

(22) Filed: Dec. 23, 2024

(51) Int. Cl. G06F 12/12

(52) U.S. Cl. CPC G06F 12/12

(57) ABSTRACT

Techniques are provided herein for allowing some level of program-directed control over cache replacement policies. Typically, cache replacement policies are controlled directly by the hardware with little to no room for intervention by software. The present disclosure allows software to specify priority hints for cache lines (units of data) in the cache. These priority hints can specify that a cache line is to have “high priority,” in which case such a cache line cannot be evicted and remains in the cache. A mechanism is also provided to eventually age out high priority cache lines, which allows for reclamation of the space used by such cache lines when space is needed.

### BACKGROUND

Processors access data in memory to perform calculations. General purpose memory typically has very high latency compared to the processing speed of processor and thus caches are used to alleviate some of these problems. Caches are generally much smaller than system memory but have much better access characteristics (e.g., lower latency and higher bandwidth). However, because caches are smaller than memory, a great deal of effort is put into attempting to store data likely to be used in the future into caches. Mistakes made in such efforts can hinder performance. For example, cache space occupied by data that is never or rarely used is wasted space, especially if other data that is actually used is not in the cache. Thus, improvements to caching operations are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 illustrates a cache system according to an example;

FIG. 4 illustrates the cache storage of the cache, according to an example;

FIG. 5 illustrates the cache, showing information within the cache storage, according to an example;

FIG. 6 illustrates an interaction for reserving a portion of the cache for use for high priority cache lines;

FIG. 7 illustrates an interaction in which a memory access request is made that specifies a priority hint;

FIG. 8 illustrates an interaction for storing a cache line into the cache where an eviction occurs;

FIG. 9 illustrates an example set associative cache, which is an example of the cache of FIG. 3; and

FIG. 10 is a flow diagram of a method for operating a cache, according to an example.

### DETAILED DESCRIPTION

While large, the relatively poor access characteristics of system memory can act as a significant bottleneck to processor operations. Thus, computer systems typically include cache hierarchies that help to alleviate such issues. Caches employ a variety of techniques to store data that is considered likely to be used by the processor in the near future. This effectively hides the latency to system memory, as a “hit” (successful access) within the cache will return data to the processor faster than system memory can.

While beneficial, successfully operating a cache is a complex task. One consideration is regarding how to select data for “eviction” (removal) from the cache in the situation that the cache is “full” (or more particularly, in the situation that data is to be stored in the cache but where there are no empty slots in the cache that are appropriate for that data). A typical manner to do this is to utilize a cache replacement policy that tracks certain information about data in the cache (such as “age”) and evicts data based on such information. Such cache replacement policies are generally good at selecting data but are not perfect, and can select data for eviction that is needed again very soon, or can perform other errors.

Techniques are provided herein for allowing some level of program-directed control over cache replacement policies. Typically, cache replacement policies are controlled directly by the hardware with little to no room for direct intervention by software. The present disclosure allows software to specify priority hints for cache lines (units of data) in the cache. These priority hints can specify that a cache line is to have “high priority,” in which case such a cache line cannot be evicted and remains in the cache. A mechanism is also provided to eventually age out high priority cache lines, which allows for reclamation of the space used by such cache lines when space is needed. Additional details are techniques are provided as well.

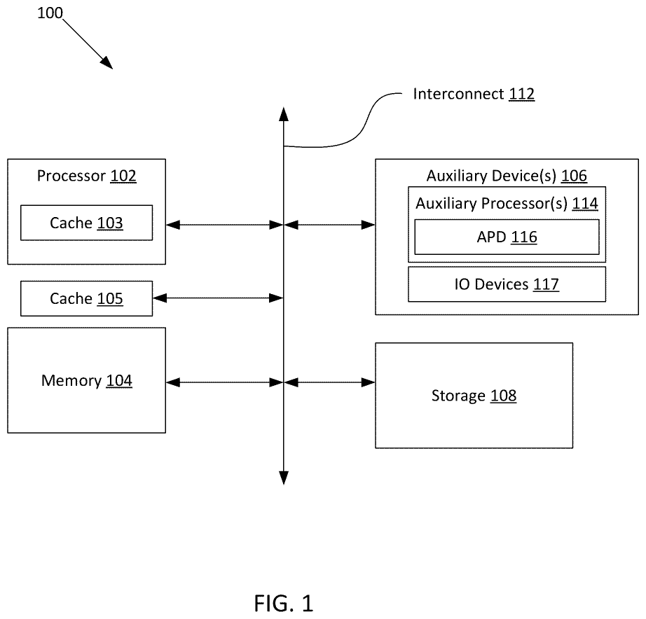

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

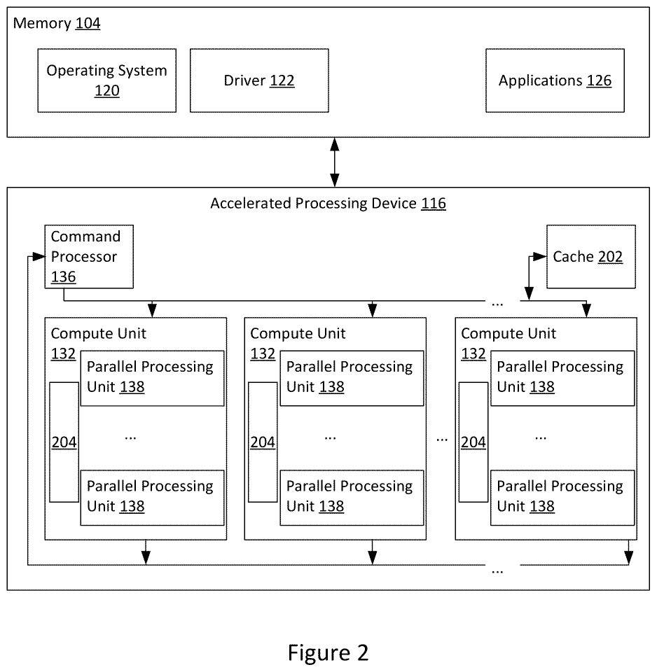

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen, thirty-two or sixty-four lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps.” One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A command processor 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

In various examples, caches are present at one or more locations in the device 100. Some example locations include within the processor (e.g., processor cache 103), external to the processor (e.g., global cache 105), and, within the APD 116, as a global APD cache 202 or as a CU (“compute unit”)-local cache 204. In these examples, the processor cache 103 services memory requests from the processor 102, the global cache 105 services memory requests from a variety of units (e.g., processor 102 or APD 116), the global APD cache 202 services requests from the various compute units 132 of the APD 116, and the CU-local cache 204 services requests from the compute unit 132 that the CU-local cache 204 is within. In various examples, these different caches are arranged in a hierarchy, where caches at a lower level in the hierarchy (e.g., level-0 caches) are first consulted to satisfy memory requests, with caches that are higher in the hierarchy serving as a backing store to fill cache line misses (e.g., such higher-level caches are consulted in the event that a miss occurs in a lower-level cache). In an example, the processor cache 103 and CU-local cache 204 are lower-level caches, the global APD cache 202 is higher than the CU-local cache 204, and the global cache 105 is higher than any of these caches. In various examples, other caches not shown are present in the device 100. The present disclosure describes operations for a cache, and such operations can be performed for any cache of a computing device such as the device 100, including caches described herein or not explicitly described herein.

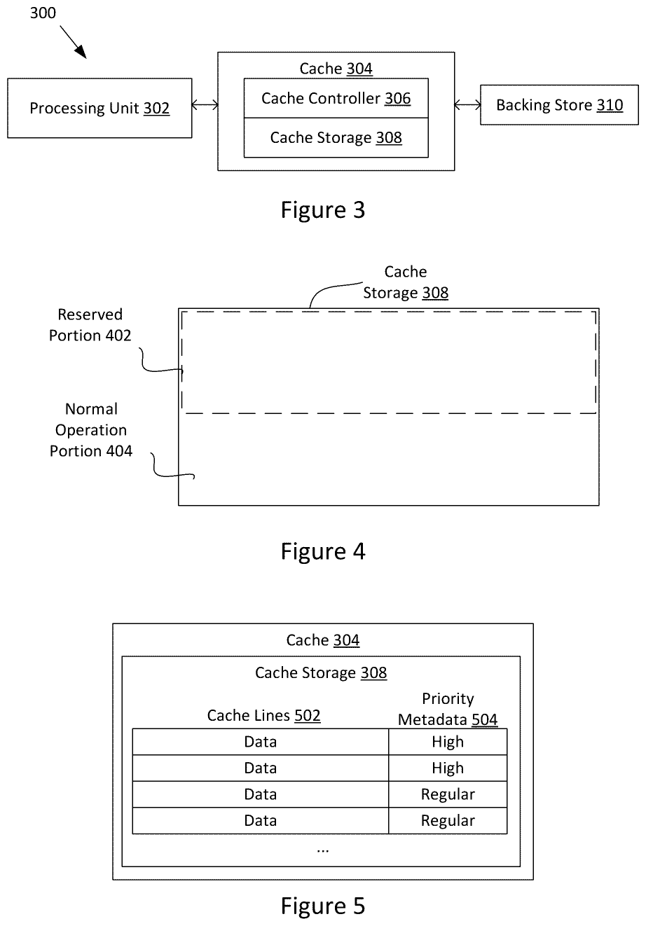

FIG. 3 illustrates a cache system 300 according to an example. The example cache system 300 includes a processing unit 302, a cache 304, and a backing store 310. The processing unit 302 is any processing unit (e.g., programmable processor or other circuitry, including the processor 102 or a parallel processing unit 138) capable of making memory requests (e.g., asking to read or write from/to an address in memory). The cache 304 hardware (e.g., circuitry) is capable of servicing such requests from an internal memory (cache storage 308), which has more limited storage area than the backing store 310 but has better access characteristics (e.g., less latency and/or better bandwidth). The cache storage 308 is the memory that actually stores such cached data and the cache controller 306 is hardware (e.g., circuitry) configured to perform operations for managing the cache (e.g., updating cache line status, managing requests from the processing unit 302, sending requests to fill the cache storage 308 when a miss occurs to the backing store 310, and so on). The backing store 310 is another (e.g., higher) level cache that can service requests for cache lines when a miss occurs or is system memory or another memory.

FIG. 4 illustrates the cache storage 308 of the cache 304, according to an example. The present disclosure contemplates the use of “high priority” (also sometimes referred to as “high temporal”) cache lines. A cache line is the smallest unit of data that is tracked with metadata in the cache and that can be evicted or read into the cache. For example, in the event of a miss, meaning that data requested by the processing unit 302 is not within the cache 304, the cache 304 fetches the cache line containing that requested data and stores that cache line into the cache storage 308. Other information, such as replacement policy information, is stored on a per-cache line basis. In an example, a least-recently-used replacement policy is used in the cache 304. According to this policy, the cache 304 tracks “age” information for various cache lines and determines which cache line to evict to make space for a new cache line that is to be stored into the cache (e.g., in the event of a miss), based on this age information. The age information is stored on a per-cache line basis, meaning that each item of age information indicates the age for one cache line.

“High priority” cache lines are cache lines that cannot be evicted. In other words, in the event that a miss occurs and the cache 304 determines that a cache line is to be evicted in order to make room for the data for which a miss has occurred, the cache controller 306 identifies a set of candidate cache lines for eviction. In some examples, these candidate cache lines are all of the cache lines in the set associated with the new cache line being stored into the cache (where “associated with” in this context means in the set specified by the address of the new cache line—the term “set” refers to a “set” in a set-associativity scheme, in which each cache line uniquely maps to a single set based on certain bits of the address of that cache line, and thus cache lines can only be evicted from that set). The set of candidate cache lines does not include, however, any cache line marked with “high priority,” meaning that no such cache line can be evicted. The present disclosure provides techniques whereby a portion of the cache storage 308 is reserved for such high priority cache lines, and subsequent use of that portion to store cache lines marked as high priority.

In general, high priority cache lines cannot be evicted unless a high priority eviction condition is met. In some examples, this is true regardless of the priority of the incoming cache line being brought in as the result of a miss. In other words, as stated above, eviction occurs in response to a miss which needs a new cache line to be brought into the cache 304. In the present disclosure, the miss occurs as a result of a memory access for data not already in the cache 304, and this memory access can itself specify a priority. This priority would be the new priority for the cache line for the data being brought into the cache. Even if this priority is “high priority” for the new cache line, the cache line that is evicted cannot be a high priority cache line. Put differently, even incoming “high priority” cache lines cannot evict cache lines that are “high priority.” Thus, in general, cache lines having “high priority” cannot be evicted from the cache.

Above it is stated that a high priority cache line can be evicted in the event that a high priority eviction condition is met. Some examples of such a condition are now described. In one example, the cache controller 306 maintains an age for all cache lines including high priority cache lines. When a miss occurs in a set (a set-associative set), the cache controller 306 increments a miss counter for that set. When the miss counter of a set arrives at a threshold, the oldest (or least-recently-used) high priority cache line in a set is converted into a regular priority cache line, which can then be evicted according to normal cache replacement policies. In another example of a high priority eviction condition, a timer based on clock cycles from the time the cache originally is brought into the cache, or a timer that measures real time from that point in time, is used. When this timer reaches a threshold, the oldest (or least-recently-used) high-priority cache line is turned into a regular priority cache line. In another example of a high priority eviction condition, a cache priority downgrade command, which may include cache writeback, flush, or invalidate commands, causes one or more of the high-priority cache lines to be turned into a regular priority line. For example, if a cache priority downgrade command targets - requests writeback, flush, or invalidation, of a cache line that is a high priority cache line, then that cache line is downgraded to a regular priority cache line (and the operations requested by the cache priority downgrade command is also performed). In another example, a power event, such as a request from a power or clock controller to put the cache into a lower-power state (such as a clock-gating or power-gating state) now or in the future causes one or more cache lines to be turned into regular priority cache lines. In another example, a cache coherence command causes a high-priority cache line to be turned into a regular-priority cache line. In another example, an error-checking calculation is periodically performed on cache lines. If the error-checking calculation shows that the value in a high-priority cache line has been corrupted, it is turned into a regular priority cache line (and in some examples is evicted). In another example, if the portion of the cache reserved for high-priority cache lines is changed, some or all of the high-priority cache lines in the cache are turned into regular priority cache lines.

A brief description of set associative caches is now provided. In a set associative cache, the cache storage 308 is divided into sets. Any particular cache line is uniquely mapped to a single set based on bits of the address of that cache line. When a memory access request arrives at the cache 304, the cache controller 306 determines whether the cache line to satisfy that request is already in the cache 304. This is done by determining which set is mapped to the address of that cache line and then searching each cache line in that set for a match (e.g., by comparing a “tag”—a portion of the cache line address—of the cache line in the cache to a tag of the cache line being requested). If a match occurs, then a hit occurs and if no match occurs, then a miss occurs. In the event of a miss, the cache 304 selects a cache line in the set for eviction in order to make room for the new cache line). If there are no free slots (e.g., if there are no cache lines marked as “invalid”) in the set, then the cache controller 306 selects one of the cache lines in the set for eviction according to a replacement policy. In a common replacement policy - “least recently used” - the age of each cache line in a set is tracked. In this instance, “age” is not necessarily related to time per se, but to the order in which cache lines are brought into the set. For instance, the first cache line brought into a set is the “oldest,” the second is the next oldest, and so on. In a simple example, the cache controller 306 increments an age of each cache line in a set when a miss occurs in that set, so that a higher age number means an older cache line. New cache lines are brought in with some initial value such as zero or another default value. It should be noted that the age is tracked among cache lines of a set, and relative ages of cache lines in different sets are generally not relevant (e.g., a cache line in one set cannot said to be “older” or “younger” than a cache line in a different set by comparing the ages of those two cache lines).

FIG. 4 illustrates a cache storage 308 having an example reserved portion 402 and a normal operation portion 404 according to an example. Above, it is stated that the processing unit 302 requests the cache 304 to reserve a certain portion of the cache 304 for high priority lines. In some examples, this reservation is made by software executing on the processing unit 302 sending a request for such reservation to the cache 304, where the request specifies an amount of space to be reserved. The cache 304 then stores an indication of which portion of the cache 304 is reserved for high priority cache lines (the reserved portion 402). The remaining portion of the cache 304 cannot be used for high priority cache lines and is indicated as the normal operation portion 404.

In operation, when the processing unit 302 sends a memory access request to the cache 304, the cache 304 checks whether the cache line for that request is already stored in the cache storage 308. If that cache line is not already in the cache 304 and the request specifies “high priority,” then the cache 304 checks whether there are available slots in the reserved portion 402 (where a “slot” is a portion of the cache storage 308 that can store a cache line). A slot is available if there is at least one empty slot in the set mapped to by the cache line to be brought into the cache that is also in the reserved portion 402. In other words, the new cache line is mapped to a particular set. If there is at least one slot in that set that is both empty (e.g., marked as “invalid”) and within the reserved portion 402, then there is at least one slot available for the new cache line. If, however, there is no empty slot in that set that is also within the reserved portion 402, then the new cache line cannot be brought in as a high priority cache line, and the cache line is instead brought in as a regular priority cache line.

In some examples, the reserved portion 402 is “soft reserved,” in that any amount of the reserved portion 402 is permitted to be used for cache lines that are not high priority, but that such lines are evicted if needed to store high priority cache lines. In other words, while the reserved portion 402 is not completely filled with high priority cache lines, the portions of the reserved portion 402 not used for high priority cache lines can be used for regular priority cache lines. However, once high priority cache lines are needed to be brought into the cache 304, the regular priority cache lines are evicted from the reserved portion 402 to make space.

As stated above, a memory access request performed by the processing unit 302 is transmitted to the cache 304 for processing. In some examples, these memory access requests are part of or embodied as instructions executed by the processing unit 302. More specifically, in various examples, the processing unit 302 is a programmable processor that executes instructions. Some such instructions request access to memory (e.g., by loading values into a register, storing values from a register to memory, or otherwise reading from and/or writing to memory). Some instructions that request access to memory specify a priority hint. In various examples, this priority hint is included in the instruction itself, such as within the opcode (e.g., as a prefix), as one of the operands, or as any other component (set of bits) that is a part of an instruction. Such priority hints signal to the cache 304 that the cache line targeted by the instruction (e.g., the cache line at the address in memory written to and/or read from by the instruction) should have the specified priority.

In some examples, the priority specified by the instruction is a hint, meaning that the cache 304 is free to ignore that hint in certain circumstances. As described above, in some examples, the cache controller 306 obeys the specified hint unless an ignore condition is met. In one example, an ignore condition for an instruction specifying an address for a cache line and a priority is that the specified priority is “high priority,” there is a miss for the cache line in the cache 304, and there are no empty slots in the cache 304 that are within the reserved portion 402. In other words, if an instruction accesses a cache line not in the cache and provides a priority hint of “high priority,” but there is no room for that cache line in the reserved portion 402, then the cache 304 ignores the hint to make the cache line high priority. In the event that the cache 304 ignores the priority hint, the cache 304 takes an action other that setting the addressed cache line to the priority specified in the priority hint. In an example, if the priority hint for an instruction triggering a miss is “high priority” but there are no empty slots for the associated cache line in the reserved portion, then the cache 304 sets the cache line to “regular priority,” so that the cache line can be stored into the normal operation portion 404.

In some examples, an instruction accesses an address for a cache line that is already in the cache 304. Further, the instruction specifies a priority hint for that cache line that is different than the priority already stored in the cache 304 for that cache line. In this situation, the cache controller 306 modifies the priority of that cache line to be the priority specified by the instruction. Stated differently, in the situation that a memory access results in an access to a cache line in the reserved portion 402, the cache controller 306 sets the priority of that cache line to the priority specified in the instruction. Put differently, a cache line in the reserved portion 402 has the priority specified by the most recently executed instruction that specified a priority hint (unless that hint was not obeyed for some reason as specified elsewhere herein - for example, due to an ignore condition).

As can be seen, it is possible to modify the priority of a cache line that is already in the cache. Thus, a cache line can be “upgraded” (e.g., converted from “regular priority” to “high priority”) or “downgraded” (e.g., converted from “high priority” to “regular priority”) by executing an instruction that accesses data in that cache line and specifies the desired priority. For example, if a cache line is already in the cache and has a “regular priority,” then upgrading that cache line is performed by executing an instruction that accesses data in that cache line and specifies “high priority” (although an upgrade will not occur in some conditions, such as if the reserved portion 402 has no empty slots). Similarly, if a cache line is already in the cache and has a “high priority,” then downgrading that cache line is performed by executing an instruction that accesses data in that cache line and specifies “regular priority.”

It should be noted that the granularity with which priority data is stored is on a cache line basis. In other words, one item of priority data (i.e., one unit of information that specifies priority) is associated with one cache line. This means that accesses to different addresses in the same cache line can utilize and/or modify the same priority data. For example, a first access to a first address in a first cache line can cause that cache line to be stored into the cache 304 with one priority (e.g., high priority), and subsequent accesses to that cache line, even at a different address (but still within the cache line) act in accordance with that priority (e.g., a subsequent instruction that specifies an address in the same cache line but specifies a different priority will change the priority of that cache line).

FIG. 5 illustrates the cache 304, showing information within the cache storage 308, according to an example. As can be seen, the cache storage 308 stores a number of cache lines 502, each with an associated item of priority metadata 504. The cache lines are processed in accordance with the teachings herein, respecting the associated priority metadata as described. In the example shown, each row has data for a cache line, as well as an associated item of priority metadata, which indicates the priority for the cache line within that row.

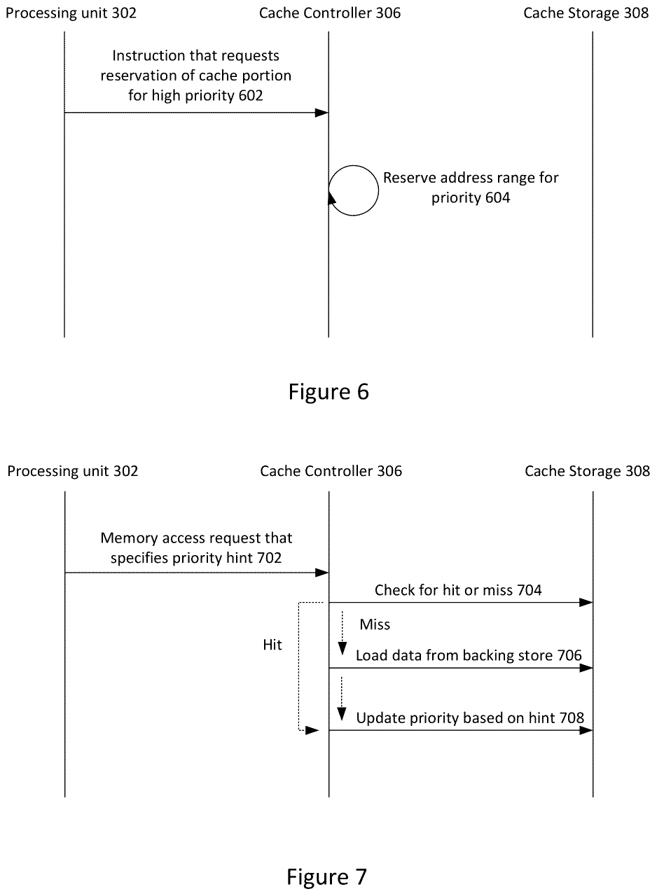

FIGS. 6-8 illustrate example interactions related to cache line priority. FIG. 6 illustrates an interaction for reserving a portion of the cache for use for high priority cache lines. In this interaction, a processing unit 302 executes an instruction that requests reservation of a portion of the cache 304 for use as a high priority portion (step 602). In response, the cache controller 306 reserves the requested portion (step 604). In various examples, the cache controller 306 performs this reservation by storing an indication of which portion of the cache 304 is considered to be reserved for high priority.

FIG. 7 illustrates an interaction in which a memory access request is made that specifies a priority hint. The memory access request specifies an address that is for a cache line. The processing unit 302 transmits such a request to the cache controller 306 for processing. This is step 702. At step 704, the cache controller 306 checks whether the access request results in a hit or a miss. This is done by checking whether the cache line for the specified address is within the cache 304. A hit occurs if the cache 304 stores the cache line and a miss occurs if the cache 304 does not store the cache line. If a miss occurs, then the cache controller 306 performs step 706, loading a cache line from the backing store 310 into the cache 304. The cache controller 306 performs step 708 if a hit or a miss occurs at step 704. At step 708, the cache controller 306 sets the priority for the cache line referenced by the memory access request (step 702). In particular, the cache controller 306 sets this priority to the priority specified by the access request.

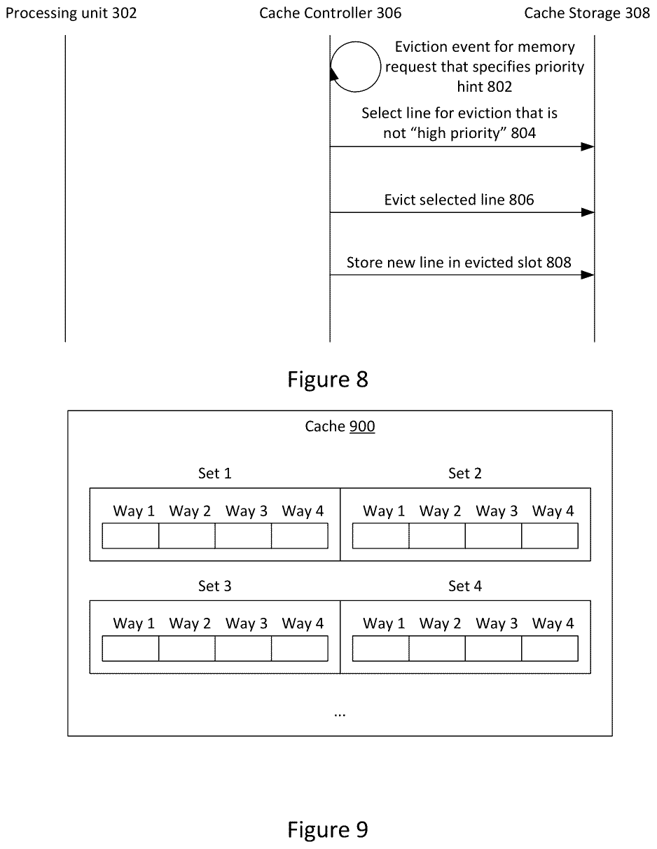

In some examples, step 706, which loads the cache line into the cache 304, causes an eviction. More specifically, if there are no available slots for the cache line being loaded into the cache 304, then an eviction occurs in order to store the cache line into the cache. FIG. 8 illustrates an interaction for storing a cache line into the cache 304 where an eviction occurs. At step 802, the cache controller 306 detects an eviction event for a memory request that specifies a priority hint. An eviction event is an event that requires an eviction to occur. In one example, an eviction event occurs when a miss occurs for a memory access request and there are no empty slots for the cache line for that request. At step 804, the cache controller 306 selects a line for eviction. The cache controller 306 does not select a line that is considered “high priority,” but instead selects a cache line that has a different priority, such as “regular priority.” At step 806, the cache controller 306 evicts the selected line. In some examples, this eviction includes one or more of writing the cache line back to the cache storage 308 if the cache line is dirty, invalidating the cache line, or performing other operations. At step 808, the cache controller 306 stores the new cache line from the backing store into the slot in the cache storage 308 from which the cache line was evicted.

FIG. 9 illustrates an example set associative cache 900, which is an example of the cache 304 of FIG. 3. The illustrated cache 900 includes four sets, each having four ways, though an actual cache would have many more sets (and can have a different number of ways). In a set associative cache, any given cache line is mapped to a single set. When the cache line is to be brought into the cache, the cache controller 306 identifies the set and then selects one of the ways in that set to place the cache line into. The combination of a set and a way is a “slot” in the cache. For example, set 1, way 1 stores one cache line, set 3, way 3 stores another cache line, and so on. When a cache line is to be brought into the cache (e.g., as the result of a miss), if there are no empty (invalid) ways in the set mapped to the cache line, then the cache controller 306 evicts one of the cache lines in one of the ways and places the new cache line into that slot. The manner in which such a cache line is selected for eviction is the replacement policy. In an example of a least recently used replacement policy, the cache controller 306 maintains an age for the cache lines in a set and selects a cache line for eviction based on this age.

In some examples, each set can include one or more cache lines that are marked as high priority and one or more cache lines that are marked as regular priority. In some such examples, the cache controller 306 maintains ages (or other replacement data) for each such cache line, but does not evict a cache line marked as high priority. In some examples, if a high priority cache line is downgraded to regular priority, the age of that cache line is available for use in the cache replacement policy.

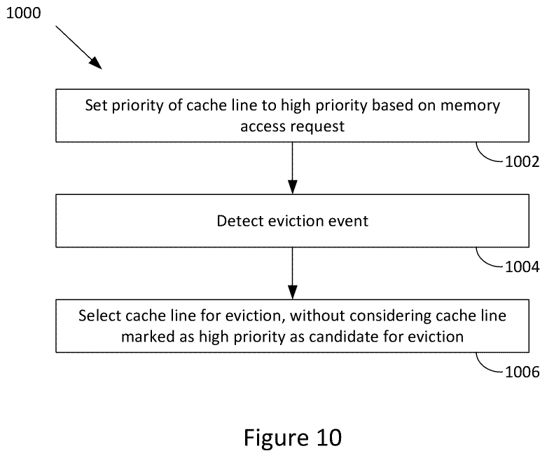

FIG. 10 is a flow diagram of a method 1000 for operating a cache, according to an example. Although described with respect to the system of FIGS. 1-9, those of skill in the art will understand that any system configured to perform the steps of the method 1000 in any technically feasible order falls within the scope of the present disclosure.

At step 1002, the cache controller sets a priority of a cache line to high priority based on a memory access request. More specifically, a memory request for an address is made, such as a memory request made as a result of an instruction requesting to access memory (e.g., a load or store instruction). This instruction specifies the priority for the cache line at the address. The cache controller 306 sets the priority for that cache line. In some examples, the cache line is not in the cache (a miss occurs) and thus the cache controller 306 fetches that cache line, places that cache line into the cache, and sets the priority of the cache line to the priority requested by the memory access request. In other examples, the cache line is already in the cache and the priority for that cache line is different than the requested priority, and thus the cache controller 306 sets the new priority for that cache line to the requested priority. Although the example of FIG. 10 is one in which the cache controller 306 is able to set the priority of the cache line to the requested priority, in some examples, this is not possible, such as where the reserved portion 402 is full.

At step 1004, the cache controller 306 detects an eviction event. In some examples, the eviction event is that a subsequent memory access request is made for a cache line mapped to the same set as the cache line stored into the cache at step 1002, and that set has no empty slots (e.g., no entries that are invalid). In this event, there is no room for this new cache line and thus one cache line from that set is evicted.

At step 1006, the cache controller 306 selects a cache line for eviction for the eviction event. This selection does not consider any cache lines for eviction that have “high priority.” In particular, an eviction event causes an eviction to occur in a particular set. In some examples, the cache controller 306 selects a cache line for eviction based on a replacement policy such as least recently used. In an example where the eviction event is that a new cache line is to be stored into the cache in a set where there are no empty slots, the set involved is the set mapped to that new cache line. The cache controller 306 selects one of the cache lines, but does not consider any cache line marked as high priority because such cache lines cannot be evicted.

Subsequent to this, the cache controller 306 evicts the selected cache line. In some examples, subsequently, the cache controller 306 stores the new cache line into the slot from which the older cache line was evicted.

Above it is described that the cache storage 308 is divided into a reserved portion 402 and normal operation portion 404. In some examples, this division is made by dividing one or more sets. In other words, for each set for which such a division is made, one or more of the ways of that set are included in the reserved portion 402 and one or more other ways of the set are in the normal operation portion 404. In addition, in some examples, the size of the reserved portion 402 is limited such that at least one way in each set is available for the normal operation portion 404, which thus allows evictions to be possible for all memory accesses. In other words, because high priority cache lines cannot be evicted, if any set had slots that were all within the reserved portion 402, and a high priority cache line was in each such slot, then no such cache line could be evicted for another cache line, and it would be possible for some cache lines to never be able to be stored in the cache (since cache lines uniquely map to sets). Thus in some examples, there is always at least one cache line in each set that is not within the reserved portion 402. This also means that the request to reserve a portion of the cache storage 308 for high priority cache lines is a hint and can be at least partially ignored (for example, if too much space is requested to be reserved, in some examples, the cache controller 306 limits the amount of space in the cache storage 308 that is reserved).

Herein, the term “cache line” has one of several meanings based on context. When referring to data stored in the cache 304, a cache line is a unit of data stored in a slot in the cache. Cache lines in the cache 304 have an associated set of metadata, such as cache replacement policy metadata (e.g., age) and priority metadata. When referring to addresses, a cache line is a range of addresses (also called a “cache line address range”). An address can thus be said to be “within a cache line.” In general, cache lines are aligned to their size. This means that a certain number of the most significant bits of a cache line are all the same for all addresses within that cache line, with an offset beginning at 0 indicating an address within the cache line. The size of the offset is sufficient to specify any address within the cache line, and is based on the size of the cache line. For example, for cache lines that are 128 bytes, the offset is 7 bits, and the most significant bits (e.g., 57 bits in a 64-bit address scheme) specify the address of the cache line. An address is considered to be within the cache line if the address has identical most significant bits as the cache line.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the auxiliary devices 106, the accelerated processing device 116, IO devices 117, the command processor 136, the graphics the compute units 132, the parallel processing units 138, or the cache controller 306 (or other portions of the cache 304) may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
setting priority of a cache line in a cache to high priority based on a memory access request;
detecting an eviction event; and
selecting a cache line for eviction based on the eviction event, without considering any cache line marked as high priority as a candidate for eviction.

2. The method of claim 1, wherein the memory access request includes an instruction having an opcode or operand that specifies the high priority.

3. The method of claim 1, wherein the eviction event comprises a miss.

4. The method of claim 3, wherein the miss occurs in a cache set in which the cache line is stored.

5. The method of claim 1, further comprising evicting the cache line selected for eviction.

6. The method of claim 1, further comprising downgrading the cache line to normal priority in response to a high priority eviction condition.

7. The method of claim 1, wherein the memory access request results in a miss and the cache line having the priority set to high priority is stored into the cache based on the memory access request and in response to the miss.

8. The method of claim 1, further comprising executing an instruction to reserve a portion of the cache for high priority cache lines.

9. The method of claim 1, further comprising ignoring a priority hint of a second memory access request in response to an ignore condition occurring.

10. A system comprising:
a cache storage; and
a cache controller configured to perform operations comprising:
setting priority of a cache line in the cache storage to high priority based on a memory access request;
detecting an eviction event; and
selecting a cache line in the cache storage for eviction based on the eviction event, without considering any cache line marked as high priority as a candidate for eviction.

11. The system of claim 10, wherein the memory access request includes an instruction having an opcode or operand that specifies the high priority.

12. The system of claim 10, wherein the eviction event comprises a miss.

13. The system of claim 12, wherein the miss occurs in a cache set in which the cache line is stored.

14. The system of claim 10, wherein the operations further comprise evicting the cache line selected for eviction.

15. The system of claim 10, wherein the operations further comprise downgrading the cache line to normal priority in response to a high priority eviction condition.

16. The system of claim 10, wherein the memory access request results in a miss and the cache line having the priority set to high priority is stored into the cache based on the memory access request and in response to the miss.

17. The system of claim 10, wherein the operations further comprise executing an instruction to reserve a portion of the cache for high priority cache lines.

18. The system of claim 10, wherein the operations further comprise ignoring a priority hint of a second memory access request in response to an ignore condition occurring.

19. A system comprising:
a processing unit; and
a cache configured to:
set priority of a cache line in the cache to high priority based on a memory access request;
detect an eviction event; and
select a cache line for eviction based on the eviction event, without considering any cache line marked as high priority as a candidate for eviction.

20. The system of claim 19, wherein the memory access request includes an instruction having an opcode or operand that specifies the high priority.
